(19) United States
(12) Patent Application Publication
(10) Pub. No.: US 2009/0036248 A1
(43) Pub. Date: Feb. 5, 2009

(54) DRIVE WITH A TORQUE SPLIT TRANSMISSION

(75) Inventors: Matthias Mueller, Neusaess (DE); Steffen Mutschler, Ulm (DE)

Correspondence Address: SCULLY SCOTT MURPHY & PRESSER, PC, 400 GARDEN CITY PLAZA, SUITE 300, GARDEN CITY, NY, 11530, US

(73) Assignee: Bosch Rexroth AG, Stuttgart (DE)

(21) Appl. No.: 12/279,143

(22) PCT Filed: Mar. 13, 2007
(86) PCT No.: PCT/EP07/02214

§ 371 Date: Aug. 12, 2008

(30) Foreign Application Priority Data
Mar. 13, 2006 (DE) 10 2006 011 443.4

(51) Int. Cl. F16H 47/04; B60K 17/10

(52) U.S. Cl. 475/72; 475/116

(57) ABSTRACT

The invention concerns a drive with a torque split transmission (1). The torque split transmission (1) includes a hydraulic pump (9) and a hydraulic motor (12), which are connected to each other via a first work line (10) and a second work line (11). The drive also has at least one first storage element (21) to store braking energy, it being possible to connect the at least one first storage element (21) to the first work line (10) or second work line (11). The hydraulic pump (9) and the hydraulic motor (12) are connected mechanically to a driven shaft (18).

The invention concerns a drive with a torque split transmission and a storage element to store braking energy.

To drive commercial vehicles, often drive systems in which two drive trains are driven by one primary drive motor are used. On the one hand, a mechanical drive is used, and in a second branch, a hydrostatic drive. In the hydrostatic drive, a hydraulic pump and a hydraulic motor act together, it being possible to connect the hydraulic motor to the travel drive. Such a drive system is proposed in U.S. Pat. No. 4,215,545. There, an output shaft of a primary drive motor can be connected via two clutches to a mechanical branch or a hydraulic pump. The hydraulic pump can be connected via a first work line and a second work line to a hydraulic motor. To make it possible to reverse the direction of the flow, a distribution valve, which can exchange the connections between the hydraulic motor and the hydraulic pump, is provided. To recover energy after a braking process, a storage element can be connected to one of the two work lines via an on-off valve. To store and recover energy, the storage element is connected to one work line. During the braking operation, the distribution valve is switched so that the hydraulic motor, which acts as a pump, conveys pressurising medium into the storage element. To recover the energy, pressurising medium is taken from the storage element via the on-off valve and fed to the hydraulic motor.

In the case of the described drive system, it is disadvantageous that to store the energy, the hydraulic motor is used exclusively. Additionally, because of the connection of the storage element to only one of the work lines via the on-off valve, the additional distribution valve is required, so that the corresponding connection of the hydraulic motor can be connected to the storage element.

The invention is based on the object of creating a drive with a torque split transmission, wherein improved recovery of the kinetic energy during the braking process is possible, and wherein switching between the connections of the hydraulic pump and hydraulic motor is not required.

The object is achieved by the drive according to the invention, with the features of Claim 1.

The drive according to the invention and Claim 1 includes a torque split transmission, which includes a hydraulic pump and a hydraulic motor. The hydraulic pump and the hydraulic motor are connected to each other via a first work line and a second work line. The hydraulic pump and the hydraulic motor, together with the first and second work lines, form a closed hydraulic circuit. A first branch of the torque split transmission is formed by the closed hydraulic circuit. To store kinetic energy during a braking process, a first storage element can be connected to the first work line or second work line. Because of the connection of the first storage element to the first or second work line, the connections between the hydraulic pump and hydraulic motor can always remain unchanged, since the work line to which pressurising medium is applied by the hydraulic motor or by the hydraulic pump during the braking process can be connected to the first storage element. The hydraulic motor and the hydraulic pump are each connected mechanically to a driven shaft.

In the subclaims, advantageous further developments of the drive according to the invention are explained.

According to a preferred embodiment, the hydraulic motor is connected via a mechanical transmission to the driven shaft of the torque split transmission. According to the invention, the mechanical transmission includes at least one first planetary gear train. One element, e.g. the internal gear, of the first planetary gear train is connected to the first hydraulic motor, and another element, e.g. the sun wheel, of the first planetary gear train is connected to the hydraulic pump. By connecting one element to the hydraulic motor and simultaneously another element of the planetary gear train to the hydraulic pump, it is possible in overrunning or braking operation to convert the kinetic energy, both by means of the hydraulic motor and by means of the hydraulic pump, into pressure energy, and thus, by storing it in the first storage element, to make it available for recovery.

It is also advantageous if the torque split transmission includes a mechanical power branch a hydraulic power branch, and the two power branches can be operated jointly or independently of each other.

In particular, it is advantageous to provide a clutch, with which the drive motor can be decoupled from the torque split transmission. Then, in the case of recovery of kinetic energy, the complete braking energy, which is fed back in the drive train because of mass inertia, is stored by the hydraulic motor and hydraulic pump jointly in the first storage element, in the form of pressure energy. If this braking effect is insufficient, by engaging the clutch the drive motor can also be connected to the torque split transmission. If the drive motor is additionally connected to the torque split transmission, its braking power can also be used, and the total braking power can be increased.

It is also advantageous to provide, in the torque split transmission, a first drive shaft section and a second drive shaft section, which jointly form the drive shaft of the torque split transmission. The drive shaft section is connected to the hydraulic pump, and the second drive shaft section is connected to the sun wheel of the first planetary gear train. The connection between the first drive shaft section and the second drive shaft section can be released, so that the hydraulic pump can be decoupled from the sun wheel of the first planetary gear train. Such an arrangement has the advantage that use of the hydrostatic branch of the torque split transmission alone is also possible. In this case, the drive motor is connected, via the first drive shaft section, only to the hydraulic pump.

According to a further advantageous embodiment, the torque split transmission includes a second planetary gear train. The second planetary gear train also has a sun wheel and an internal gear, the internal gear of the first planetary gear train being connected to the internal gear of the second planetary gear train. Thus both internal gears of the two planetary gear trains are jointly connected to the hydraulic motor. The two sun wheels are also connected to each other, because both the sun wheel of the first planetary gear train and the sun wheel of the second planetary gear train are connected to the second drive shaft.

Such an arrangement makes it possible to decouple the first drive shaft section from the second drive shaft section, and to implement a purely hydrostatic travel drive. The various transmission ratios of the planetary gear train can be chosen so that in contrast to the drive via both branches of the planetary gear train, a lower speed range is covered. To achieve a corresponding input rotational speed for the planetary gear train when both branches of the torque split transmission are used, it is specially advantageous to connect the first drive shaft section and the second drive shaft section to each other via a transmission stage. The planet carrier of the second planetary gear train can be blocked.

The planet carrier of the first planetary gear train is connected to a driven shaft of the torque split transmission.

During storage and recovery of the stored kinetic energy, the first storage element is connected to the first or second work line. The drive preferably has a second storage element, which during the storage process and/or the recovery of the energy is connected to the other work line. The hydraulic motor is connected to the hydraulic pump as stated above, in a closed hydrostatic circuit. The result of storing or recovering kinetic energy is that pressurising medium is removed from or fed back into the circuit. This volume flow is equalised by the second storage element, the equalisation taking place on the low pressure side. In particular, it is advantageous to design the first store as a high pressure store and the second store as a low pressure store. It can also be specially advantageous to connect a storage pressure maintaining device with a pressure maintaining valve upstream from the high pressure store. Such a storage pressure maintaining device prevents the first storage element being completely emptied unintentionally.

Also, it is preferred if in braking operation above a pressure limit in the first storage element, the drive motor is switched off.

Advantageous embodiments are shown in the drawings and explained in more detail in the following description.

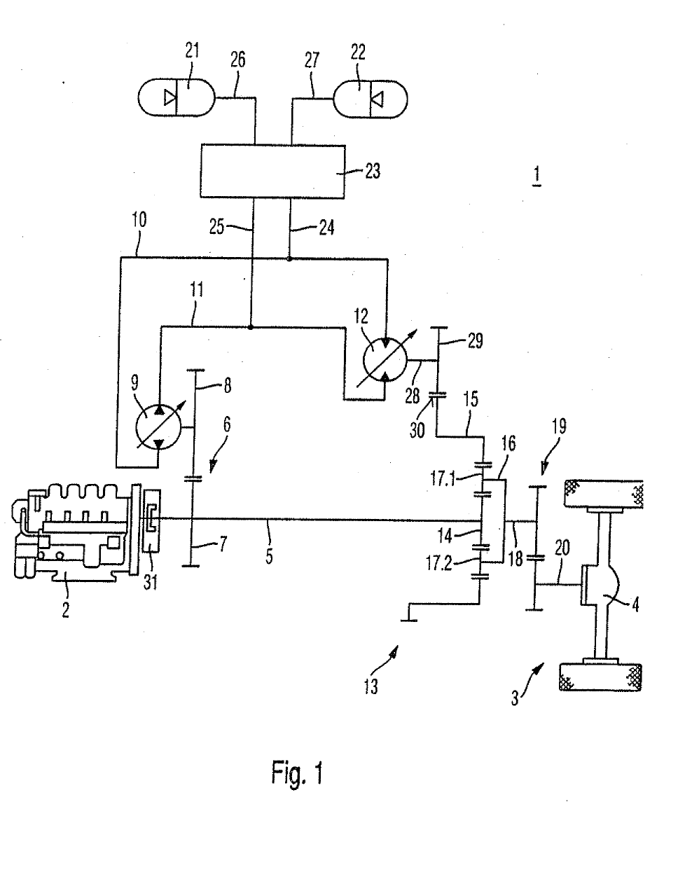

FIG. 1 shows a first embodiment of a drive according to the invention,

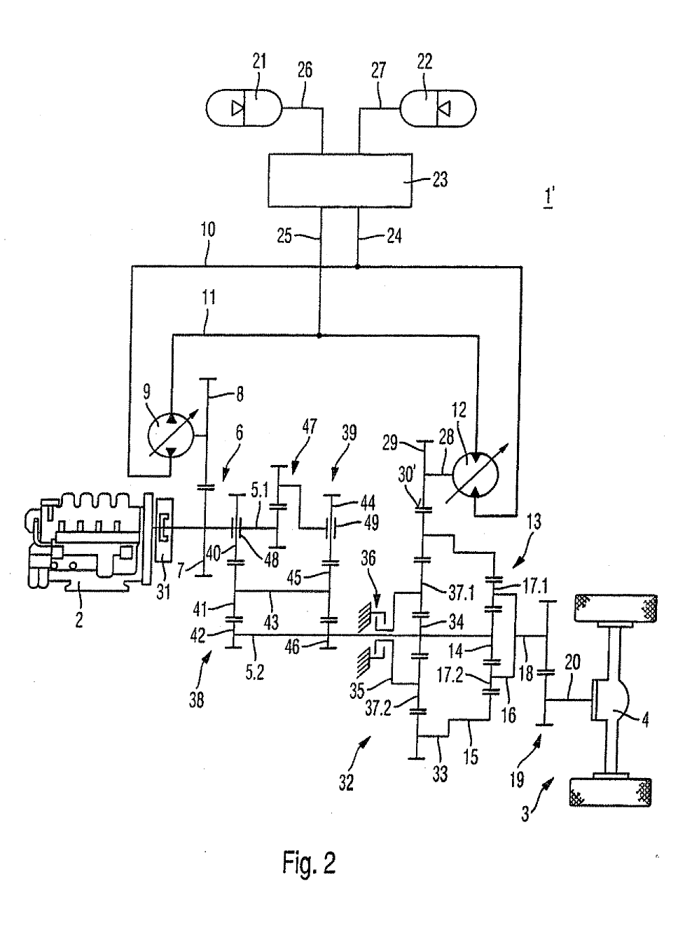

FIG. 2 shows a second embodiment of a drive according to the invention,

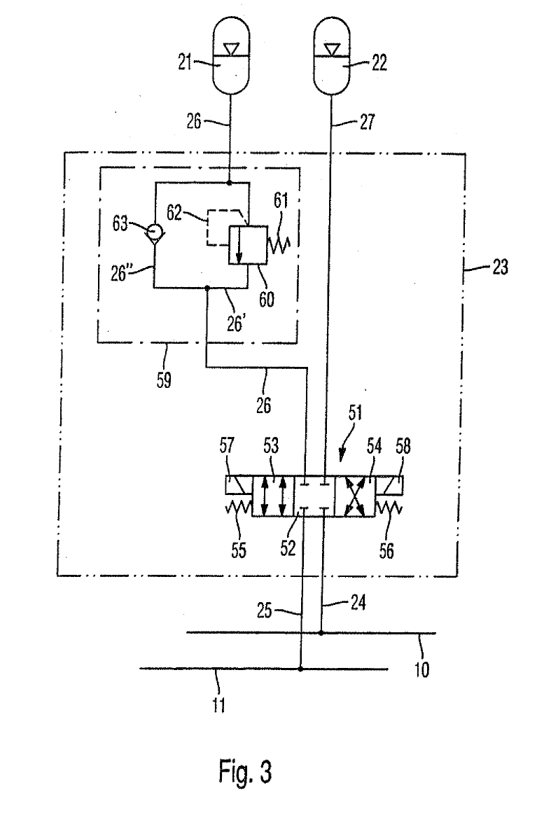

FIG. 3 shows a first embodiment of a valve block,

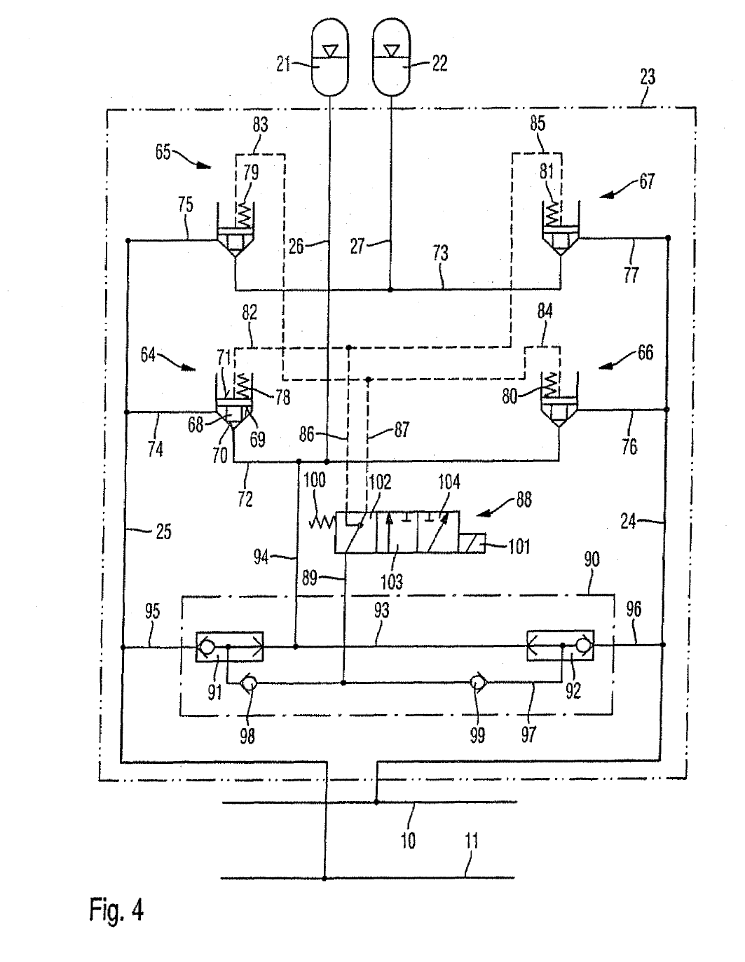

FIG. 4 shows a second embodiment of a valve block,

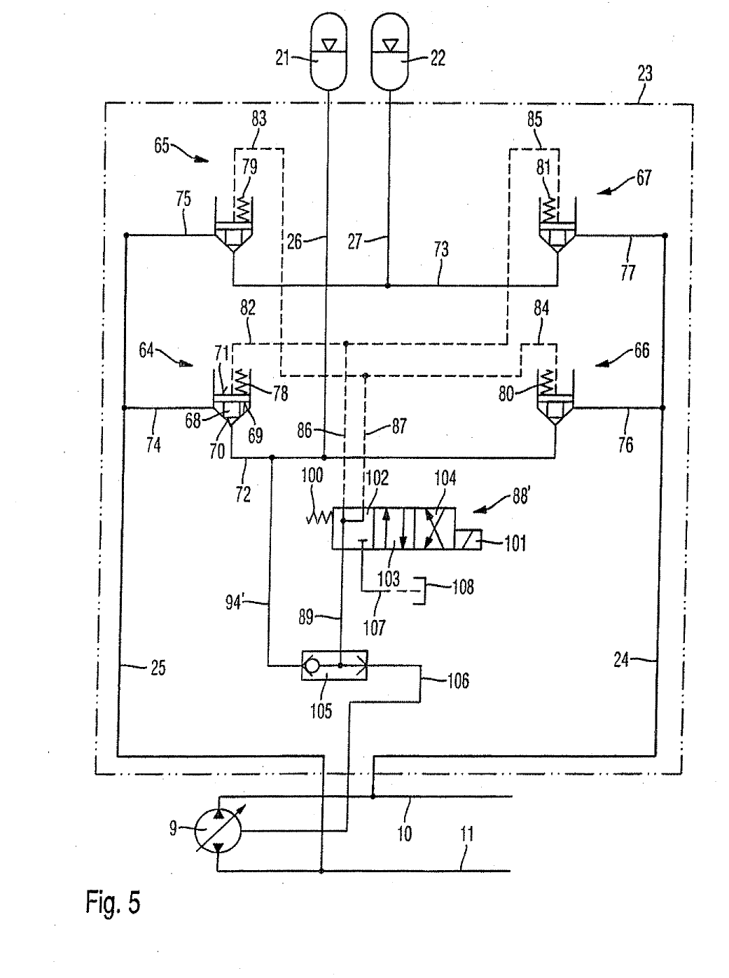

FIG. 5 shows a third embodiment of a valve block,

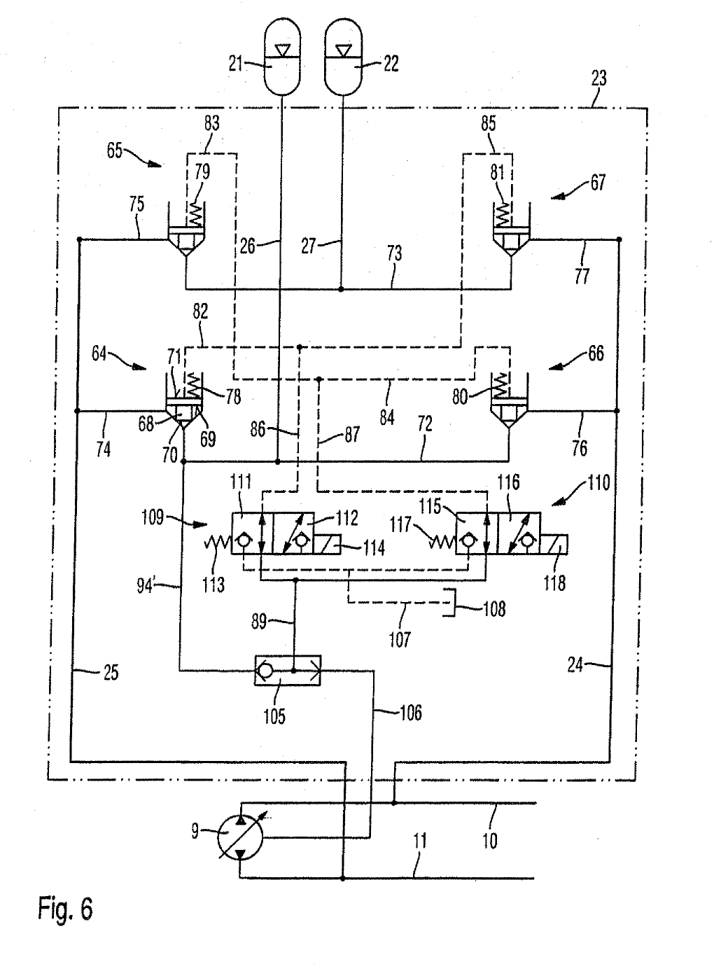

FIG. 6 shows a fourth embodiment of a valve block, and

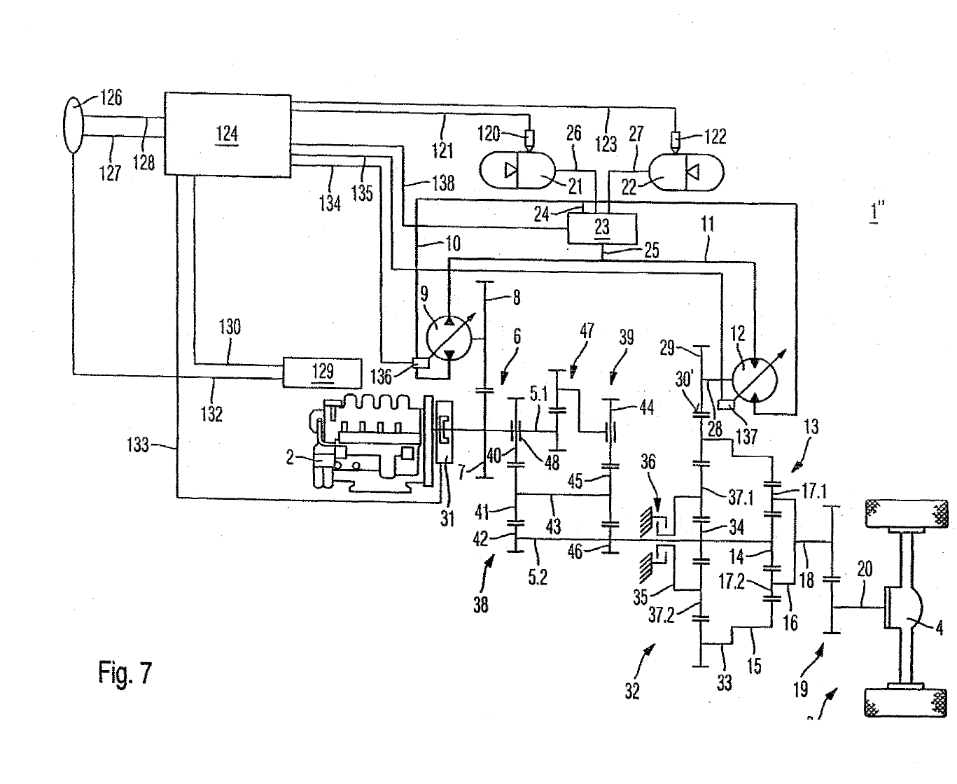

FIG. 7 shows a third embodiment of a drive according to the invention, with control components.

In FIG. 1, a first embodiment of a drive according to the invention is shown. A torque split transmission 1 includes a drive motor 2, by which a driven axle 3 of, for instance, a wheel loader is driven. In the shown embodiment, this is a single vehicle axle 3. However, a transfer case of an all wheel drive can equally well be driven by the torque split transmission 1. The driven axle 3 has a differential 4, through which the vehicle wheels are driven.

The drive motor 2 can be connected to a drive shaft 5, through which the torque which the drive motor 2 generates is fed to the torque split transmission 1. Via a first transmission stage 6, a hydraulic pump 9 is connected to the drive shaft 5. The first transmission stage 6 has a first spur gear 7 and a second spur gear 8. The first spur gear 7 and the second spur gear 8 engage permanently with each other, so that the drive shaft 5 is permanently connected to the hydraulic pump 9.

The hydraulic pump 9 is designed to convey pressurising medium in two directions, and its conveyed volume is adjustable. The hydraulic pump 9 is adjusted by an adjustment device (not shown), which is preferably controlled by an electronic control unit.

A first work line 10 and a second work line 11 are connected to the hydraulic pump 9. A hydraulic motor 12 is connected to the hydraulic pump 9 via the first work line 10 and second work line 11. The hydraulic motor 12 is also designed for two conveying directions, and its absorption volume is also adjustable. The hydraulic pump 9, together with the hydraulic motor 12 and the first and second work lines 10, 11, forms a closed hydraulic circuit. The hydraulic pump 9 and hydraulic motor 12 are preferably implemented as axial piston machines. For instance, swash plate or sloping axle machines can be used.

The hydraulic motor 12 is connected via a hydraulic motor output shaft 28 to a third spur gear 29. Via the third spur gear 29, the hydraulic motor 12 acts on a mechanical transmission, in the shown embodiment a first planetary gear train 13. The first planetary gear train 13 has a sun wheel 14 and an internal gear 15. The first planetary gear train 13 also includes a planet carrier 16, on which multiple planetary gears 17.1, 17.2 are arranged and rotatably carried on it. The planet carrier 16 of the first planetary gear train 13 is connected to a driven shaft 18, and transmits its output torque via a second transmission stage 19 to a differential input shaft 20 to the driven axle 3 of the vehicle. The connection of the hydraulic pump 9 and hydraulic motor 12 to the sun wheel 14 and internal gear 15 is merely an example. Depending on the desired transmission ratio, the elements of the planetary gear train 13 (sun wheel 14, internal gear 15 and planet carrier 16) can also be assigned differently. In any case, a mechanical connection of both the hydraulic pump 9 and the hydraulic motor 12 to the driven shaft 18 and/or the drive train of the vehicle exists.

During driving, the drive shaft 5 is driven by the drive motor 2. The sun wheel 14 of the first planetary gear train 13 is connected to the drive shaft 5. Simultaneously, via the first transmission stage 6, the hydraulic pump 9, and depending on the set displaced volume or set absorption volume of the hydraulic motor 12, the hydraulic motor output shaft 28, are driven. Thus the third spur gear 29, which engages with gearing 30 which is arranged on the outside of the internal gear 15 of the first planetary gear train 13, is driven by the hydraulic motor output shaft 28. Thus both the sun wheel 14 and the internal gear 15 of the first planetary gear train 13 are driven either directly by the drive motor 2 or via the hydrostatic branch of the torque split transmission 1. This results in a rotational movement of the planet carrier 16, and this movement is transmitted via the driven shaft 18, the second transmission stage 19 and the differential input shaft 20 to the driven axle 3 of the vehicle. In the shown embodiment of the torque split transmission 1, power is transmitted via both the hydrostatic branch and the mechanical branch to the driven axle 3.

If the vehicle goes into overrunning operation, the flow of force is reversed, and because of the mass inertia of the vehicle, a torque is now fed from the driven axle 3. The internal gear 15 and sun wheel 14 are now driven via the first planetary gear train 13, through the planet carrier 16. In this way, because of the permanent connection between the drive shaft 5 and the hydraulic pump 9, both the hydraulic motor 12 and the hydraulic pump 9 are driven. To be able to exploit the released kinetic energy as fully as possible, a clutch 31, by which the drive motor 2 can be decoupled from the drive shaft 5, is provided. The clutch 31 can be implemented as a single-disc dry clutch, for instance. So that the braking power, i.e. the released kinetic energy of the vehicle, can be stored, at least one storage element is provided. In the shown embodiment, the storage element is a first hydraulic accumulator 21. A second hydraulic accumulator 22 is also provided, as a further storage element. The first hydraulic accumulator 21 is preferably in the form of a high pressure store. The second hydraulic accumulator 22, in contrast, is in the form of a low pressure store, and provided to equalise the volume flow which is fed in and out.

To be able to connect the first hydraulic accumulator 21 and second hydraulic accumulator 22 to the first work line 10 and second work line 11 respectively, a valve block 23 is provided. The valve block 23 is connected to the first work line 10 via a first connecting line 24. Additionally, the valve block 23 is connected to the second work line 11 via a second connecting line 25. The first hydraulic accumulator 21 is connected via a high pressure storage line 16 to the valve block 23, whereas the second hydraulic accumulator 22 is connected via a low pressure storage line 27 to the valve block 23. Embodiments of the valve block 23 are explained in detail below, with reference to FIGS. 3-6.

Depending on the direction of travel, in the hydrostatic circuit pressurising medium is conveyed either clockwise or anticlockwise. For the following explanations, let it be assumed that pressurising medium is conveyed clockwise, and let this be described below as forward travel. In such forward travel, therefore, during a normal drive, pressurising medium is conveyed into the first work line 10 by the hydraulic pump 9, and released into the second work line 11 via the hydraulic motor 12. If the vehicle now goes into overrunning operation or is braked, the pressure conditions are reversed. The hydraulic motor 12 now acts as a pump, and conveys pressurising medium into the second work line 11 while increasing the pressure.

By adjusting the adjustment device of the hydraulic pump 9, it can also be achieved that the hydraulic pump 9, which is driven via the drive shaft 5, reverses its conveying direction, and thus also conveys pressurising medium into the second work line 11. The pressurising medium which is conveyed by the hydraulic pump 9 and hydraulic motor 12 into the second work line 11 is fed to the first hydraulic accumulator 21. For this purpose, the second connecting line 25 is connected to the high pressure storage line 26 by the valve block 23. From the second work line 11, pressurising medium, which is under high pressure, is conveyed via the second connecting line 25 and high pressure storage line 26 into the first hydraulic accumulator 21. Simultaneously, the second hydraulic accumulator 22 is connected to the first work line 10 by the valve block. For this purpose, in the valve block 23, the low pressure storage line 27 is connected to the first connecting line 24. Consequently, the pressurising medium which is conveyed into the first hydraulic accumulator 21 is taken from the second hydraulic accumulator 22. Both the hydraulic pump 9 and the hydraulic motor 12 suck pressurising medium from the first work line 10 and convey it into the second work line 11, from which it is stored in the first hydraulic accumulator 21, increasing the pressure there.

If the braking power because of the increase of pressure in the first hydraulic accumulator 21 is insufficient, the drive shaft 5 can additionally be supported on the drive motor 2. In this case, the connection between the drive motor 2 and the drive shaft 5 remains, the clutch 31 not being disengaged.

To recover the braking energy, or the vehicle's kinetic energy which is stored in the first hydraulic accumulator 21 in the form of pressure energy, the pressurising medium from the first hydraulic accumulator 21 is fed again to the hydrostatic circuit. If acceleration in the forward direction takes place, the high jerk storage line 26 is connected to the first connecting line 24 by the valve block 23. Thus the pressurising medium which is stored in the first hydraulic accumulator 21 is fed to the first work line 10. The pressure energy can be fed back simultaneously via both the hydraulic pump 9 and the hydraulic motor 12. Thus pressurising medium can be applied to both the hydraulic pump 9 and the hydraulic motor 12 via the first work line 10, so that both the hydraulic pump 9 and the hydraulic motor 12 act as motors, and transmit torque to the drive shaft 5 and/or the hydraulic motor output shaft 28. The torque which the hydraulic pump 9 generates thus supports the torque which is transmitted by the drive motor 2 onto the drive shaft 5. It is also possible to set the hydraulic pump 9 for negligible conveyed volume. Thus the whole pressure energy which is stored in the first hydraulic accumulator 21 is fed back directly via the hydraulic motor 12.

While pressurising medium is taken from the first hydraulic accumulator 21 via the first work line 10, the second hydraulic accumulator 22 is connected to the second work line 11. For this purpose, the valve block 23 connects the second connecting line 25 to the low pressure storage line 27. The pressurising medium which is fed back from the first hydraulic accumulator 21 is thus carried away into the second hydraulic accumulator 22, to equalise volumes. The recovery of the vehicle's kinetic energy which becomes free during the braking process results in lower fuel consumption and reduced brake wear when the vehicle is operated. Such an arrangement is specially advantageous in the case of vehicles which frequently go through acceleration and braking cycles. Such vehicles are, for instance, wheel loaders or refuse collection vehicles. The arrangement according to the invention, in which the first hydraulic accumulator 21 can be connected alternately to the first work line 10 and second work line 11, has the advantage that the hydraulic motor 12 does not have to be pivoted beyond its zero position. The direction of flow through the hydraulic motor 12 can be retained at the transition from driving to overrunning operation. This results in increasing the stability of the driving state. The result is also increased available power for when driving is resumed, since in addition to the power of the drive motor 2, the stored energy can be used to accelerate the vehicle.

In FIG. 2, a second embodiment of the drive according to the invention is shown. Those elements which correspond to the elements of FIG. 1 are given identical reference symbols. A general, repeated description is omitted, to avoid repetitions. In the case of the second embodiment, the mechanical transmission has, as well as the first planetary gear train 13, a second planetary gear train 32. The second planetary gear train 32 includes an internal gear 33 and a sun wheel 34. Between the internal gear 33 and the sun wheel 34 of the second planetary gear train 32, planetary gears 37.1 and 37.2, which are fixed rotatably on a planet carrier 35, are arranged. The planet carrier 35 can be blocked by means of a blocking device 36. In the shown embodiment, the internal gear 15 of the first planetary gear train 13 and the internal gear 33 of the second planetary gear train 32 are joined into a common internal gear. The gearing 301 is arranged in the area of the internal gear 33 of the second planetary gear train 32. Via the gearing 30′, the hydraulic motor 12 is connected to the common internal gear 15, 33 of the first planetary gear train 13 and second planetary gear train 32. The planetary gear trains 13 and 32 have different transmission ratios.

The drive shaft of the torque split transmission 1′ of FIG. 2 is divided into two, and includes a first drive shaft section 5.1 and a second drive shaft section 5.2. The second drive shaft section 5.2 is permanently connected to the sun wheel 14 of the first planetary gear train 13 and the sun wheel 34 of the second planetary gear train 32. The first drive shaft section 5.1 is connected to the drive motor 2 so that it can be released, a clutch 31 also being provided here, to make the connection releasable. The first transmission stage 6, which connects the hydraulic pump 9 to the first drive shaft section 5.1, is also connected to the first drive shaft section 5.1.

To connect the first drive shaft section 5.1 to the second drive shaft section 5.2, a third transmission stage 38 and a fourth transmission stage 39 are provided. The third transmission stage 38 includes fourth, fifth and sixth spur gears 40, 41 and 42. The sixth spur gear 42 is permanently connected to the second drive shaft section 5.2. The fifth spur gear 41 is connected to an intermediate shaft 43. The fourth spur gear 40 is connected to the first drive shaft section 5.1 so that it can be released.

For permanent connection of the fourth spur gear 40 to the first drive shaft section 5.1, a second clutch 48 is provided. The second clutch 48 can either be implemented as a friction clutch like the clutch 31, or be a positive clutch. The third transmission stage 38 is provided for forward driving, for instance. On the other hand, the fourth transmission stage 39 is used to generate the same transmission ratio for reverse driving. The fourth transmission stage has seventh, eighth and ninth spur gears 44, 45 and 46, which like the fourth to fifth spur gears 40-42 permanently engage with each other. The seventh spur gear 44 is connected to a direction of rotation reverser 47 so that it can be released. The eighth spur gear 45 is connected to the intermediate shaft 43 and thus to the fifth gear wheel 41. The fifth transmission stage 39 is completed by the ninth spur gear 46, which is permanently connected to the second drive shaft section 5.2. For forward driving, in which both the hydrostatic branch and the mechanical branch are used for driving, the second clutch 48 is closed, whereas the third clutch 49 is opened. For reverse driving with both the mechanical branch and the hydrostatic branch, the second clutch 48 is opened and the third clutch 49 is closed.

The direction of rotation reverser 47 has a pair of gear wheels, by which the direction of rotation of the seventh spur gear 44 relative to the direction of rotation of the fourth spur gear 40 is reversed. To achieve equal driving speed ranges in the forward and reverse directions, the transmission ratios of the third transmission stage 38 and fourth transmission stage 39 are preferably identical.

In the case of the embodiment of FIG. 2, it is also possible to use a driving range in which the hydrostatic branch is used exclusively. In such driving operation, both the second clutch 48 and the third clutch 49 are opened. Simultaneously, the blocking device 36 is activated. The blocking device 36 can be, for instance, a positive clutch, to which the planet carrier 35 of the second planetary gear train 32 is fixed on the housing side.

Because of the different transmission ratios of the first planetary gear train 13 and second planetary gear train 32, in the case of torque introduction by the hydraulic motor 12, via the hydraulic motor output shaft 28 and the third spur gear 29 which is connected to it, onto the internal gears 15, 33 of the first planetary gear train 13 and second planetary gear train 32, the result is rotation of the planet carrier 16 of the first planetary gear train 13 and thus torque on the driven shaft 18.

If the vehicle is in this driving speed range, in which driving takes place only via the hydrostatic branch of the torque split transmission 1′, in the case of a braking process, because of the missing connection between the first drive shaft section 5.1 and second drive shaft section 5.2, braking energy can be recovered exclusively via the hydraulic motor 12. Without fully pivoting the hydraulic motor 12, pressure, which can be stored in the first hydraulic accumulator 21, is generated in the downstream work line by the hydraulic motor 12, which now acts as a pump. To make storage of released kinetic energy possible, preferably the hydraulic pump 9 is set to negligible conveyed volume. For the case of forward driving, the hydraulic motor 12 generates a pressure, in the second work line 11 which is downstream from the hydraulic motor, and the valve block 23 connects the second connecting line 25 to the high pressure storage line 26. Consequently, when the pressure is increased in the first hydraulic accumulator 21, kinetic energy is stored in the first hydraulic accumulator 21 in the form of pressure energy. Simultaneously, in the way described above, the valve block 23 connects the low pressure storage line 27 to the first connecting line 24, so that the volume flow can be equalised by the second hydraulic accumulator 22.

In the second driving speed range, the blocking device 36 is not used, and the planet carrier 35 of the second planetary gear train 32 can rotate freely. Simultaneously, in the case of forward driving, the second clutch 48 is engaged, and thus connects the first drive shaft section 5.1 to the second drive shaft section 5.2. Because of the use of an intermediate shaft 43, the directions of rotation of the first drive shaft section 5.1 and second drive shaft section 5.2 correspond. In this connection state, the function is identical to the function described above with reference to FIG. 1, with a direct connection of the sun wheel 14 of the first planetary gear train 13 to the drive motor 2. Consequently, in the shown embodiment of FIG. 2, it is likewise possible, in the second driving range, to store the released kinetic energy by conveying pressurising medium through the hydraulic pump 9 and simultaneously through the hydraulic motor 12 into the first hydraulic accumulator 21. Similarly, the stored energy can be recovered either via the hydraulic motor 12 alone or via both the hydraulic motor 12 and the hydraulic pump 9. For exclusive generation of a braking effect by storing the released kinetic energy, here too the first drive shaft section 5.1 can be separated from the drive motor 2 by the clutch 31.

All operating situations which have been explained above exclusively for forward driving with conveyance of hydrostatic pressurising medium clockwise in the hydraulic circuit also apply analogously to reverse driving. In the case of the embodiment of FIG. 2, it should merely be noted that in the second driving range, the second clutch 48 is opened and the third clutch 49 is closed. In contrast to the above description in the case of forward driving, the pressure ratios in the first and second work lines are reversed, and the first work line 10 becomes the downstream work line relative to the hydraulic motor 12, and must be connected to the first hydraulic accumulator 21 to store energy.

When the stored energy is recovered, simultaneously the direction of travel can be reversed. This means that the valve block 23 can feed back the pressurising medium, which is stored in the first hydraulic accumulator 21, also into the work line from which it was taken for storage. For instance, if a vehicle, during forward driving, is first braked to zero, by feeding back pressurising medium into the second work line 11, acceleration from a standstill in the reverse direction can be achieved.

Detailed embodiments of the valve block 23 to connect the two hydraulic accumulators 21, 22 to the work lines 10, 11 are shown in FIGS. 3-6.

A first, simple embodiment of a valve block 23 is shown in FIG. 3. To connect the first connecting line 24 to the high pressure storage line 26 or the low pressure storage line 27, or the second connecting line 25 to the high pressure storage line 26 or the low pressure storage line 27, the valve block 23 includes a direction of travel valve 51. The direction of travel valve 51 is a 4/3 way valve. In a neutral position 52, all four connections of the direction of travel valve 51 are separated from each other. There is thus no connection through which flow is possible between the high pressure storage line 26 or the low pressure storage line 27 and the two connecting lines 24, 25. In this connection state of the direction of travel valve 51, if pressurising medium is already stored in the first hydraulic accumulator 21, because of the complete disconnection from the hydrostatic circuit longer-term storage of pressurising medium is possible. Leakage is prevented by this separation.

From the neutral position 52, the direction of travel valve 51 can be brought into a first switching position 53 or a second switching position 54. In the first switching position 53, the first connecting line 24 is connected to the low pressure storage line 27, and the second connecting line 25 is connected to the high pressure storage line 26. In contrast, in the second switching position 54, the first connecting line 24 is connected to the high pressure storage line 26, and the second connecting line 25 is connected to the low pressure storage line 27. During a braking process in the forward direction, the direction of travel valve 51 is brought into its first switching position 53. Acceleration in the forward direction is possible if the direction of travel valve 51 is in its second switching position 54. Correspondingly, in the cases of reverse braking and forward acceleration, the opposite switching positions are taken. To ensure that the direction of travel valve 51 returns to its neutral position, a first centring spring 55 and a second centring spring 56 are provided. In the same direction as the first centring spring 55, a first electromagnet 57 acts on the direction of travel valve 51 as an actuator to actuate the direction of travel valve 51. When the first electromagnet 57 is actuated, the direction of travel valve 51 is brought out of its neutral position 52, against the force of the oppositely acting second centring spring 56, into its first switching position 53. Correspondingly, when a second electromagnet 58 is actuated, the direction of travel valve 51 is brought into its second switching position 54, compressing the first centring spring 5. Instead of the first and second electromagnets 57, 58, which are used as actuators in the shown embodiment, other actuators can be used. For instance, generating a hydraulic force on corresponding measuring surfaces of the direction of travel valve 51 is conceivable.

Preferably, a storage pressure maintaining device 59 is connected upstream from the first hydraulic accumulator 21. To connect the storage pressure maintaining device 59 upstream, it is arranged in the high pressure storage line 26, preferably within the valve block 23. In the storage pressure maintaining device 59, the high pressure storage line 26 branches into a first line branch 26′ and a second line branch 26″. The line branches 26′ and 26″ are arranged parallel to each other. In the first line branch 26′, a pressure limiting valve 60 is arranged as a pressure maintaining valve, to which a spring 61 is applied in the closing direction. The pressure in the first hydraulic accumulator 21 acts oppositely to the force of the closing spring 61, and is fed to a measuring surface via a measuring line 62. Thus it is possible to open the pressure limiting valve 60 only if the pressure in the first hydraulic accumulator 21 exceeds a value which is determined by the closing spring 61.

In the second line branch 26″, which is arranged parallel to it, a non-return valve 63, which opens in the direction towards the first hydraulic accumulator 61, is arranged. Feeding pressurising medium into the first hydraulic accumulator 21 is thus always possible, irrespective of the pressure there. The storage pressure maintaining device 59 thus ensures that a certain minimum pressure is always present in the first hydraulic accumulator 21, and that it is impossible to remove pressurising medium completely from the first hydraulic accumulator 21.

The first and second electromagnets 57, 58 are preferably controlled via an electronic control unit, which starting from the chosen direction of travel, controls the changeover of the electromagnets 57 and 58.

FIG. 4 shows a second embodiment of a valve block 23. In the embodiment of a valve block 23 shown in FIG. 4, the connection between the first connecting line 24 and second connecting line 25 and the high pressure storage line 26 and low pressure storage line 27 respectively is made using first to fourth seat valves 64, 65, 66 and 67. The four seat valves 64-67 preferably have the same structure. To avoid unnecessary repetitions, below only the structure of the first seat valve 64 is described in detail. Consequently, for clarity, the reference symbols of the individual elements of the seat valves are arranged only on the first seat valve 64.

The first seat valve 64 has a closing body 68, by which a first and a second pressure space are separated from each other in a closed position of the first seat valve 64. On the closing body 68, a first surface 69 is formed in the first pressure space, and a second surface 70, which is oriented in the same direction, is formed in the second pressure space. A third surface 71 is oriented in the opposite direction. A pressure can be applied to each of the three surfaces 69-71. In the same direction as the hydraulic force which acts on the third surface 71, the force of a first valve spring 78 is applied to the closing body 68. The first valve spring 78 acts on the first seat valve 64 in the closing direction.

Correspondingly, on each of the second to fourth seat valves 65-67, a valve spring 79-81 is also arranged, and acts on the appropriate seat valve 65-67 in the closing direction.

The second pressure spaces of the first seat valve 64 and third seat valve 66 are connected to each other via a first valve connecting line 72. Similarly, the second pressure spaces of the second seat valve 65 and fourth seat valve 67 are connected to each other via a second valve connecting line 73.

The first pressure space of the first seat valve 64 is connected via a first valve joining line 74 to the second connecting line 25. In the closed state of the first seat valve 64, the first valve joining line 74 is separated from the first valve connecting line 72. The first pressure space of the second seat valve 65 is connected via a second valve joining line 75 to the first connecting line 25. The first connecting line 24 is connected via a third valve joining line 76 to the first pressure space of the third seat valve 66, and via a fourth valve joining line 67 to the first pressure space of the fourth seat valve 67.

The first valve connecting line 72 is connected via the high pressure storage line 26 to the first hydraulic accumulator 21. The second valve connecting line 73 is connected via the low pressure storage line 27 to the second hydraulic accumulator 22.

As explained above, the closing bodies of the seat valves 64-67 are each acted on via a valve spring 78-81 in the direction of their closed position. If no hydraulic force acts on the third surfaces of the seat valves 64-67, the force of the valve springs 78-81 is insufficient to hold the seat valves 64-67 in their closed position. The hydraulic forces which act on the first and second surfaces of the seat valves 64-67 exceed the force of the valve springs 78-81, which act in the closing direction.

Therefore, to hold the seat valves 64-67 in their closed position, a hydraulic force on the third surface in each case is generated. To generate the hydraulic force, a control pressure can be applied to the third surface 71 of the first seat valve 64 via a first control pressure line 82. Similarly, a control pressure can be applied to the third surface of the second seat valve 65 via a second control pressure line 83, to the third surface of the third seat valve 66 via a third control pressure line 84, and to the third surface of the fourth seat valve 67 via a fourth control pressure line 85. The control pressure is fed to the first control pressure line 82 and the fourth control pressure line 85 jointly via a first line section 76. Similarly, control pressure is fed to the second control pressure line 83 and the third control pressure line 84 jointly via a second line section 87. To generate or assign the control pressure to the first line section 86 or second line section 87, a pilot valve 88 is provided.

The pilot valve 88, depending on its switching position, connects the first line section 86 and/or the second line section 87 to a maximum pressure line 89. The maximum pressure which is available in the system is fed to the maximum pressure line 89 through a maximum pressure selection device 90.

For this purpose, the maximum pressure selection device 90 has a first shuttle valve 91 and a second shuttle valve 92. The two shuttle valves 91, 92 are connected to each other via a shuttle valve connecting line 93. The shuttle valve connecting line 93 is connected via a high pressure storage line branch 94 to the first valve connecting line 72, and thus to the first hydraulic accumulator 21 via the high pressure storage line 26. Thus the pressure in the first hydraulic accumulator 21 is present at the inputs of the first shuttle valve 91 and second shuttle valve 92. Another input connection of the first shuttle valve 91 is connected via a first feed line 95 to the second connecting line 25. A second input connection of the second shuttle valve 92 is connected via a second feed line 95 to the first connecting line 24. Through the first shuttle valve 91, the pressure in the second connecting line 25 is compared with the pressure in the first hydraulic accumulator 21. Simultaneously, through the second shuttle valve 92, the pressure in the first connecting line 24 is compared with the first hydraulic accumulator 21. In each case, the higher of the two pressures is output through the first shuttle valve 91 and/or second shuttle valve 92 to their output connections. The output connections of the first shuttle valve 91 and second shuttle valve 92 are connected to each other via an output connecting line 97. In the output connecting line 97, a first non-return valve 98 and a second non-return valve 99 are arranged, the opening directions of the two non-return valves 98, 99 pointing towards each other. Between the two non-return valves 98, 99, the maximum pressure line 89 is connected to the output connecting line 97.

The pilot valve 88 is a 3/3 way valve, on which a pilot valve spring 100 acts in the direction of a first switching position 102. The pilot valve 88 has a second switching position 103 and a third switching position 104. To bring the pilot valve 88 from its first switching position 102 into the second switching position 103 or third switching position 104, an electromagnet 101 is provided as an actuator. The electromagnet 101 acts on the pilot valve 88 against the force of the pilot valve spring 100. Depending on the force which the electromagnet 101 generates, the pilot valve is brought into its second switching position 103 or its third switching position 104. If a control signal is no longer present at the electromagnet 101, the pilot valve 88 is brought back into its first switching position 102 by the force of the pilot valve spring 100. In the first switching position 102, the pilot valve connects the maximum pressure line 89 to both the first line section 86 and the second line section 87. Thus the maximum system pressure is applied to the first control pressure line 82 and second control pressure line 85 via the first line section 86. Similarly, the maximum system pressure is fed as control pressure via the second line section 87 to the second control pressure line 83 and third control pressure 84. Therefore, in the first switching position of the pilot valve 88, a control pressure corresponding to the maximum system pressure is applied to all seat valves 64-67 via the first to fourth control pressure lines 82-85. Therefore, the seat valves 64-67 are held in their closed position independently of the hydraulic forces which act in opposite directions on the first and second surfaces of the seat valves 64-67.

On the other hand, if the pilot valve 88 is brought into its second switching position 103 by current flowing through the electromagnet 101, only the first line section 86 is connected to the maximum pressure line 89. Consequently, a control pressure is applied to the third surfaces of the first seat valve 64 and fourth seat valve 85, and they are held in their closed position. On the other hand, in a manner which is not shown, the third surfaces of the second seat valve 65 and third seat valve 66 are released, so that because of the oppositely directed hydraulic forces the second seat valve 65 and third seat valve 66 are brought into their opened position. By adjusting the second seat valve 65 in the direction of its opened position, the second valve connecting line 73 is connected to the second valve joining line 75 so that a flow through it is possible. Consequently, the second connecting line 25 is connected to the low pressure storage line 27 via the second seat valve 65. Simultaneously, the third seat valve 66 is brought into its opened position, in which the first valve connecting line 72 is connected to the third valve joining line 76. Thus the first connecting line 24 is connected to the high pressure storage line 26 via the third seat valve 66. Consequently, in the first switching position 103, the first hydraulic accumulator 21 is connected to the first work line 10, and simultaneously the second hydraulic accumulator 22 is connected to the second work line 11.

To use the various connection possibilities of the work lines 10, 11 to the first or second hydraulic accumulators 21, 22, reference is made to the above explanations. If the pilot valve 88 is brought into its third switching position 104, in contrast to the second switching position 103 the second line section 87 is connected to the maximum pressure line 89. In this position, the control pressure is applied to the second control pressure line 83 and third control pressure line 84, and the second and third seat valves 65, 66 are held in the closed position. Simultaneously, the first seat valve 64 and fourth seat valve 67 are brought into their opened position. In the opened position of the first seat valve 64, the first valve joining line 74 is connected to the first valve connecting line 72. In this way, the second connecting line 25 is connected to the first hydraulic accumulator 21.

By means of the fourth seat valve 67, in its opened position, the fourth valve joining line 77 is connected to the second valve connecting line 73, so that the second hydraulic accumulator 22 is connected to the first connecting line 24. Consequently, in the second switching position of the pilot valve 88, the first work line 10 is connected to the second hydraulic accumulator 22, and the second work line 11 is connected to the first hydraulic accumulator 21.

In FIG. 5, another embodiment of the valve block 23 is shown. The structure corresponds essentially to that of FIG. 4, a single shuttle valve 105 being used, instead of the maximum pressure selection device, to generate and provide the maximum available system pressure. The shuttle valve 105 is connected on one side to the high pressure storage line branch 94 and on the other side to a conveyed pressure line 106. The conveyed pressure line 106 is connected at its other end to the hydraulic pump 9, and feeds the higher pressure which is available in the work lines at the time to the single shuttle valve 105. Thus the maximum system pressure at the time is provided by the single shuttle valve 105 at its output, which is connected to the maximum pressure line 89. The comparison is done by the single shuttle valve 105, directly between the pressure in the first hydraulic accumulator 21 and the higher of the two work line pressures.

Additionally, a fourth connection, which is connected via a release line 107 to a tank volume 108, is added to the pilot valve 88′.

While in the second switching position 103 of the pilot valve 88′ the maximum pressure line 89 is connected to the first line section 86, simultaneously the second line section 87 is connected via the release line 107 to the tank volume 108. In this way the second seat valve 65 and third seat valve 66 are released at their respective third surface. Conversely, while the second line section 87 is connected to the maximum pressure line 89 in the third switching position 104 of the pilot valve 88′, the first line section 86 is connected to the release line 107 and thus to the tank volume 108. In this way, the third surfaces of the first seat valve 64 and fourth seat valve 67 are discharged into the tank volume. The function corresponds to the function of the valve block 23 shown in FIG. 4, so that a repeated description of the method of functioning is omitted.

Another embodiment of a valve block 23 for the drive according to the invention is shown in FIG. 6. As in the case of the embodiment of FIG. 5, here too the maximum system pressure is selected via a single shuttle valve 105. However, instead of a single pilot valve 881, here a first pilot valve 109 and a second pilot valve 110 are provided. The first pilot valve 109 has a first switching position 111 and a second switching position 112. In the first switching position 111, in the direction of which the first pilot valve 109 is held because of the force of a compression spring 113, the first line section 86 is connected to the maximum pressure line 89. If the first pilot valve 109 is brought into its second switching position 112 by an actuating magnet 114 against the force of the first compression spring 113, the first line section 86 is connected to the release line 107.

The second pilot valve 110 also has a first switching position 115 and a second switching position 116. In the first switching position 115, in the direction of which the second pilot valve 110 is acted on by a second compression spring 117, the maximum pressure line 89 is connected to the second connecting line 87. On the other hand, if the second pilot valve 110 is brought into its second switching position 116 by the second actuating magnet 118, the release line 107 is connected to the second connecting line 87. The two actuating magnets 114 and 115 are controlled so that during braking operation and during recovery of stored energy, in each case one pilot valve 109 or 110 respectively is in its first switching position 111 or 115 respectively, and the other pilot valve 110, 109 is in the other switching position 116 or 112 respectively. As in the previous examples, the result is that the control pressure is applied to either the first line section 86 or the second line section 87. Simultaneously, the other line section 87 or 86 is connected to the release line 107. Consequently, either the first seat valve 64 and fourth seat valve 67 are closed and the second seat valve 65 and third seat valve 66 are opened, or vice versa.

In FIG. 7, another representation of the drive 1′ according to the invention of FIG. 2 is shown. The drive 1″ shown in FIG. 7 includes, as well as the previously known drive components, the control components which are required to control the drive 1″. In particular, a first pressure sensor 120, which is connected via a first sensor line 121 to an electronic controller 124, is provided. The storage pressure in the first storage element 21 is captured using the pressure sensor 120.

Correspondingly, a second pressure sensor 122 is provided, to capture the pressure in the second storage element 22. The second pressure sensor 122 is also connected via a second sensor line 123 to the electronic controller 124. For exchanging data with other controllers which are connected to the vehicle electronics, an interface 126 is provided. Via the interface 126, the electronic controller 124 can be connected to a CAN bus, for instance. In the shown embodiment, the electronic controller 124 is connected to the CAN bus, which is represented by the interface 126, via further signal lines 127 and 128. Via these further signal lines 127 and 128, information about a setpoint speed vₛₑₜₚₒᵢₙₜ and an actual speed v_{actual} should be fed to the first controller 124 of the drive 1″, for instance. Then, depending on the ratio of the setpoint speed vₛₑₜₚₒᵢₙₜ and actual speed v_{actual}, the electronic controller 124 can set the pivoting angle of the hydraulic pump 9 and/or hydraulic motor 12. Thus the transmission ratio in the hydraulic power branch can be adapted to the required braking moment.

Additionally, control of the drive motor 2 is integrated into the electronic control by the electronic controller 124. The drive motor 2 is controlled by a motor controller 129. For instance, the motor controller 129 is connected to an injection pump, so that an injection quantity for the drive motor 2 is measured out on the basis of the setting of the motor controller 129.

The motor controller 129 is connected via a motor controller signal line 130 to the electronic controller 124, and via an information signal line 132 to the interface 126.

The electronic controller 124 is also connected via an actuating line 133 to the optional clutch 31. Using the actuating line 133, for instance an actuator of the clutch 31 can be controlled. Such an actuator can be implemented as an electromagnet, for instance.

Via still more control signal lines 134 and 135, the electronic controller 124 is connected to a first adjustment device 136 and a second adjustment device 137. The first adjustment device 136 acts on an adjustment mechanism of the hydraulic pump 9. Correspondingly, the second adjustment device 136 acts on an adjustment mechanism of the hydraulic pump 12. In addition to controlling the adjustment devices 136, 137, a third control signal line 138, which applies a control signal to the valve block 23, and thus controls the connection between the first work line 10 and second work line 11 and the high pressure storage line 26 and low pressure storage line 27 respectively, is provided.

In the case of the drive according to the invention with a torque split transmission, it is preferred if during a braking process, the drive motor 2 is switched off. Using the first pressure sensor 120 and second pressure sensor 121, a storage state of the high pressure store, i.e. the first storage element 21, which has sufficient pressure energy then to be able to start the drive motor 2 reliably, is determined. For this purpose, in the simplest case, only the pressure value which is determined by the first pressure sensor 120 is compared in the first storage element 21 with a first pressure limit. If the pressure in the first storage element 21 exceeds this pressure limit, the drive motor 2 is switched off by the electronic controller 124 and the motor controller 129 which it controls.

Similarly, to restart the drive motor 2, the stored pressure energy is determined from at least the signal of the first pressure sensor 120. Preferably, the pressure difference between the pressure signals of the first pressure sensor 120 and second pressure sensor 122 is used as the basis for determining a sufficient pressure energy. If the available pressure energy to start the drive motor 2 undershoots a second limit, the drive motor 2 is automatically restarted. For this purpose, the electronic controller 124 transmits a start signal to the clutch 31 or its actuator, so that the drive motor 2 is connected mechanically to the hydraulic pump 9. To start the drive motor 2, the valve block 23 is then actuated via the signal line 138, so that the available pressure in the first storage element 21 is applied to the hydraulic pump 9. The hydraulic pump 9 consequently acts as a hydraulic motor, and generates an output torque with which the drive motor 2 is started.

During braking operation, the first adjustment device 136 and second adjustment device 137 are controlled as specified by the electronic controller 124. Thus during the braking operation, both the hydraulic pump 9 and the hydraulic motor 12 can be used to store pressure energy in the first storage element 21. Thus the hydraulic motor 12 together with the hydraulic pump 9, or the hydraulic motor 12 only, or the hydraulic pump 9 only, can be used to store pressure energy. In particular, the hydraulic pump 9 can be set for negligible conveyed volume, and simultaneously the clutch 31 can be opened. Thus all the kinetic energy which is released during the braking process is stored by the hydraulic pump 12 in the storage element 21.

The first storage element 21 is shown in the embodiments as a single hydraulic accumulator. However, it is also conceivable to provide multiple storage elements, e.g. arranged in parallel. About all the embodiments which are shown in the figures, it should be noted that the two power branches, i.e. the hydraulic power branch with the hydraulic pump 9 and the hydraulic motor 12 which is connected to it in the closed circuit, together with the mechanical power branch, can be operated, and so can the two power branches separately and independently of each other. In particular, it should be noted that a greater transmission ratio can be achieved if in addition to the two planetary gear trains shown as examples in FIGS. 2 and 7, a third planetary gear train is provided. Obviously, the control components which are shown in FIG. 7 in connection with the embodiment of drive 1′ in FIG. 2 can also be transferred to the other drives.

The invention is not restricted to the shown embodiments. In particular, combinations of individual aspects of the individual embodiments are possible in any way.

1. Drive with a torque split transmission, which includes a hydraulic pump, and a hydraulic motor which is connected to it via a first work line and a second work line,
wherein
at least one first storage element can be connected to the first work line or second work line to store braking energy, and that the hydraulic pump and the hydraulic motor are connected mechanically to a driven shaft.

2. Drive according to claim 1,
wherein
the torque split transmission includes at least one planetary gear train, and the hydraulic motor is connected to one element, and the hydraulic pump is connected to another element, of the planetary gear train.

3. Drive according to claim 1,
wherein
the torque split transmission includes a mechanical power branch and a hydraulic power branch, and moment can be transmitted both via one of the power branches and via both power branches.

4. Drive according to claim 1,
wherein
the torque split transmission can be driven by a drive motor, and the drive motor can be decoupled from the torque split transmission by means of a clutch.

5. Drive according to claim 1,
wherein
the torque split transmission has a first planetary gear train, and a first drive shaft section which is connected to the hydraulic pump, and a second drive shaft section which is connected to the first planetary gear train, and the first drive shaft section can be connected to the second drive shaft section so that it can be released.

6. Drive according to claim 4,
wherein
the torque split transmission includes a second planetary gear train, the sun wheel of which is also connected to the second drive shaft section, and the internal gear of which is connected to the internal gear of the first planetary gear train.

7. Drive according to claim 5,
wherein
the first drive shaft section and second drive shaft section can be connected to each other via at least one transmission stage.

8. Drive according to claim 6,
wherein
the planet carrier of the second planetary gear train can be blocked.

9. Drive according to claim 5,
wherein
the planet carrier of the first planetary gear train is connected to a driven shaft of the torque split transmission.

10. Drive according to claim 1,
wherein
the drive has a second storage element, which in the case of a first storage element being connected to one of the two work lines, is connected to the other work line.

11. Drive according to claim 1
wherein
during braking operation and above a pressure limit in the first storage element, the drive motor is switched off.
